(19) United States
(12) Patent Application Publication
(10) Pub. No.: US 2009/0184446 A1
(43) Pub. Date: Jul. 23, 2009

(54) METHOD AND SYSTEM FOR STRETCHING POLYMER FILM

(75) Inventors: Masaki KAWATA, Fujinomiya-shi (JP); Yasunori Iwasa, Minami-ashigara-shi (JP); Nobuyoshi Suzuki, Minami-ashigara-shi (JP); Shinsuke Aoshima, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/357,911

(22) Filed: Jan. 22, 2009

(30) Foreign Application Priority Data
Jan. 23, 2008 (JP) 2008-012779

(51) Int. Cl. C08J 3/28; B29C 55/02

(52) U.S. Cl. 264/481; 264/292; 425/383; 425/174.4; 425/384

(57) ABSTRACT

In a polymer film stretching system, a tentering machine draws polymer film of cellulose acylate containing additive of triphenyl phosphate in a transverse direction while the polymer film is guided continuously and heated. A stretching chamber contains the tentering machine. A far infrared heater and heat roller heat the polymer film before entry to the stretching chamber to set temperature of the polymer film upon entry to the stretching chamber in a range equal to or higher than T+10 (deg. C.) and equal to or lower than T+80 (deg. C.), where T (deg. C.) is a condensation temperature of the additive evaporated in the stretching chamber. Furthermore, a film dispenser supplies the polymer film from a film roll to the tentering machine.

### BACKGROUND OF THE INVENTION

1. Field of the Invention

The present invention relates to a method and system for stretching polymer film. More particularly, the present invention relates to a method and system for stretching polymer film, in which off-gas generated in the course of stretching is prevented from condensing on surfaces of the polymer film.

2. Description Related to the Prior Art

A polymer film, such as cellulose ester film, is widely used as a polarizing film in a liquid crystal display panel. In the film manufacture, the polymer film is stretched with heat for the purpose of imparting optical performance as desired.

At least one additive is contained in the polymer film to be stretched with heat. Some of additives may have a high boiling point. Examples of additives as high boiling component include triphenyl phosphate (TPP), biphenyl diphenyl phosphate (BDP), and the like.

A solution casting process is a method of producing the polymer film. A tentering machine is used in the solution casting process containing residual solvent, and carries out heat stretch of the polymer film. Tenter clips or tenter pins are incorporated in the tentering machine for clamping or retaining web edges of the polymer film. To this end, the polymer film is dried to such a strength as to be retained mechanically. In a transition area extending from a casting support for polymer solution toward the tentering machine, the polymer film is passed and subjected to evaporation of a great amount of solvent from the polymer film. Feed rollers, which are arranged in a transition area to support the polymer film, may be polluted with deposit of the solidified or evaporated additive from the polymer film upon evaporation of the solvent. The feed rollers with such dirt of the additive are likely to pollute the polymer film. Thus, optical performance of the polymer film may be lowered seriously.

JP-A 2002-086474 discloses a method in which the polymer film with a residual solvent of an amount in a predetermined range is stripped, and is transported in a transition area by the feed rollers having a predetermined hardness. Also, JP-A 2002-292658 discloses a method in which the polymer film with a residual solvent of an amount in a predetermined range is transported in contact with the feed rollers of which a surface roughness and surface energy are kept in predetermined ranges. Thus, the additive in a solidified or evaporated state can be prevented from easily depositing on the feed rollers. Optical performance of the polymer film can be kept high as the feed rollers can be free from dirt.

However, it is impossible even according to JP-A 2002-086474 and 2002-292658 to prevent the additive completely from depositing the polymer film after the heat stretch. Although the polymer film produced by any process may be drawn by the heat stretch, the method of each of those documents is usable only in the solution casting process specifically in which rollers transport the polymer film containing residual solvent of an amount in a predetermined range.

In the off-line stretching, namely the heat stretch for the polymer film obtained after the solution casting process or melt casting, the polymer film must be kept at a higher temperature than in the heat stretch in the process of the solution casting process. This is because no solvent is contained in the polymer film. Molecules of the polymer must be facilitated only with heat energy in the off-line stretching. The additive in the polymer film is likely to evaporate in the off-line stretching.

A stretching chamber contains various components of the tentering machine. Among the additives, the additive as high boiling component is likely to condense on the polymer film within the stretching chamber when its inner temperature becomes higher than the boiling point and becomes lower again. The additive as high boiling component is likely to solidify or crystallize on the surface of the polymer film in a solid phase. After exiting from the stretching chamber, the polymer film may be polluted and become defective in view of quality of a product.

To solve this problem, there is a conceivable method in which off-gas containing the additive as high boiling component in the stretching chamber is drawn, and the additive in the gas phase is removed from the off-gas, and the residual component of the off-gas is introduced back to the stretching chamber. However, there is a shortcoming in that the off-gas must be cooled down to a temperature of the condensation of the additive for the purpose of removing the additive by drawing the off-gas with heat.

The off-gas before being introduced again must be heated for high temperature. An additional heater for the off-gas, and a device for recovery of the additive are required. A manufacturing cost will be raised by those additional structures.

### SUMMARY OF THE INVENTION

In view of the foregoing problems, an object of the present invention is to provide a method and system for stretching polymer film, in which off-gas generated in the course of stretching is prevented from condensing on surfaces of the polymer film.

In order to achieve the above and other objects and advantages of this invention, a polymer film stretching method includes a step of drawing polymer film containing additive in a transverse direction while the polymer film is guided continuously and heated, by use of a tentering machine contained in a stretching chamber. The polymer film is heated before entry to the stretching chamber to set temperature of the polymer film upon entry to the stretching chamber in a range equal to or higher than T+10 (deg. C.) and equal to or lower than T+80 (deg. C.), where T (deg. C.) is a condensation temperature of the additive evaporated in an upstream end of the stretching chamber.

In the heating step, far infrared rays or near infrared rays are applied to the polymer film.

In one preferred embodiment, in the heating step, heated air is blown to the polymer film.

In another preferred embodiment, in the heating step, a peripheral surface of a heat roller contacts the polymer film.

The polymer film is supplied from a film roll to the tentering machine.

The polymer film contains cellulose acylate, the additive is triphenyl phosphate, and an inner temperature of the stretching chamber is equal to or higher than 140 deg. C. and equal to or lower than 240 deg. C.

Furthermore, gaseous medium is drawn out of the stretching chamber. The additive is removed from the gaseous medium. The gaseous medium is heated after removal. The gaseous medium is introduced after heating into the stretching chamber.

The stretching chamber includes a first zone positioned on an upstream side, and conditioned at a first inner temperature. A second zone is positioned downstream from the first zone, and conditioned at a second inner temperature higher than the first inner temperature. A cooling zone is positioned downstream from the second zone, and conditioned at a cooling inner temperature lower than the second inner temperature.

Also, a polymer film stretching system includes a tentering machine for drawing polymer film containing additive in a transverse direction while the polymer film is guided continuously and heated. A stretching chamber contains the tentering machine. A preheater heats the polymer film before entry to the stretching chamber to set temperature of the polymer film upon entry to the stretching chamber in a range equal to or higher than T+10 (deg. C.) and equal to or lower than T+80 (deg. C.), where T (deg. C.) is a condensation temperature of the additive evaporated in an upstream end of the stretching chamber.

The preheater includes a far infrared heater for applying far infrared rays to the polymer film.

In another preferred embodiment, the preheater includes a heat roller for contacting the polymer film with a peripheral surface thereof.

Furthermore, a film dispenser supplies the polymer film from a film roll to the tentering machine.

Consequently, off-gas generated in the course of stretching is prevented from condensing on surfaces of the polymer film, because the polymer film before entry to the stretching chamber is preheated to suitable temperature.

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating an off-line stretching system for stretching polymer film;

FIG. 2 is a plan illustrating a tentering machine;

FIG. 3 is a side elevation illustrating the tentering machine;

FIG. 4 is a graph illustrating distribution of an inner temperature of a stretching chamber.

### DETAILED DESCRIPTION OF THE PREFERRED

### Embodiment(s) of the Present Invention

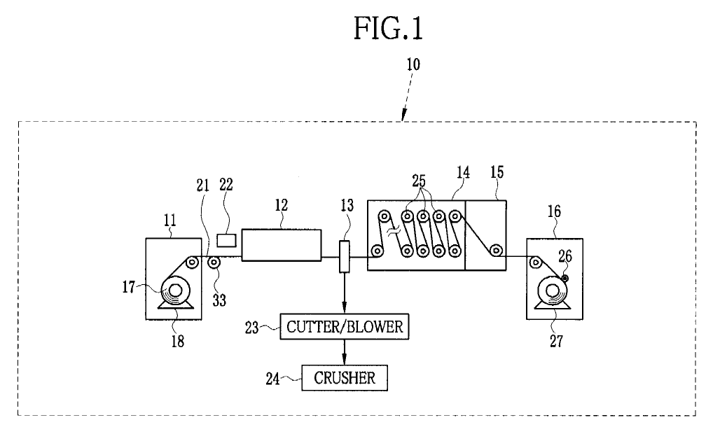

In FIG. 1, an off-line stretching system 10 for stretch of polymer film includes a film supply chamber 11, a tentering machine 12, an edge slitter 13, a heating chamber 14, a cooling chamber 15, and a film receiving chamber 16.

A film dispenser 18 is contained in the film supply chamber 11. A film roll 17 is loaded in the film dispenser 18, which advances polymer film continuously. A spindle is incorporated in the film dispenser 18 and supports the film roll 17.

A far infrared heater 22 and a heat roller 33 as a preheater are disposed shortly upstream from the tentering machine 12. A polymer film 21 is preheated by the far infrared heater 22 and the heat roller 33 before entry to the tentering machine 12. Then the polymer film 21 travels into the tentering machine 12.

Web edges of the polymer film 21 are clamped by tenter clips in the tentering machine 12, and are transported while the tenter clips move. A first series of the tenter clips becomes more distant from a second series of the tenter clips in the downstream direction, to apply tension to the film in the transverse direction for stretch. The polymer film 21 becomes heated, and its temperature rises. Note that a ratio of the stretch is suitably determined according to its optical performance.

The polymer film 21 stretched by the tentering machine 12 is transported to the edge slitter 13. The edge slitter 13 slits the polymer film 21 along slitting lines to remove web edge portions which have been clamped by tenter clips. A cutter/blower 23 is supplied with the removed web edge portions, and cuts those into numerous pieces. A crusher 24 is supplied with the pieces by a blower (not shown), and cuts the pieces into chips. The chips will be reused for preparation of dope.

The polymer film 21 after slitting away the web edge portions in the edge slitter 13 is transported to the heating chamber 14. A great number of rollers 25 and a duct (not shown) are disposed in the heating chamber 14. The rollers 25 transport the polymer film 21 in the heating chamber 14 during application of heat, before the polymer film 21 is transported to the cooling chamber 15. The temperature of the hot air from the duct is preferably in a range equal to or higher than 20 deg. C. and equal to or lower than 250 deg. C. If the polymer film 21 is cellulose acylate film, the temperature of a gas stream from the duct in the heating chamber 14 is preferably equal to or higher than 20 deg. C. and equal to or lower than 240 deg. C. Note that the heating chamber 14 may not be used. However, it is preferable to use the heating chamber 14 for the purpose of eliminating residual stress in the polymer film 21 stretched in the tentering machine 12 by application of heat to the polymer film 21.

The polymer film 21 is cooled in the cooling chamber 15 down to the temperature equal to or lower than 30 deg. C., and transported to the film receiving chamber 16. A film winder 27 is disposed in the film receiving chamber 16, and includes a press roller 26. A spindle in the film winder 27 winds the polymer film 21 while the press roller 26 presses the polymer film 21.

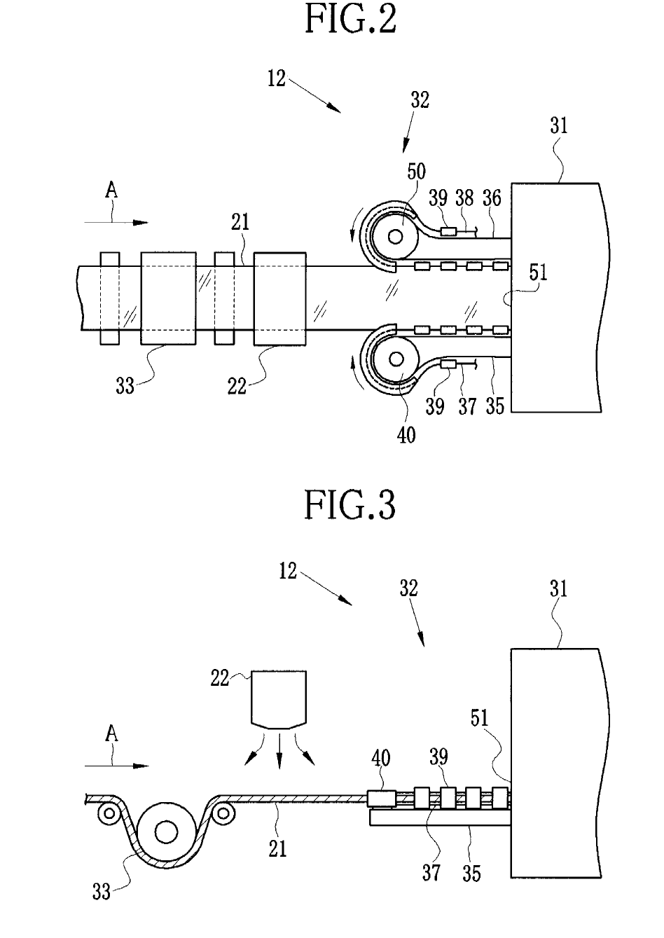

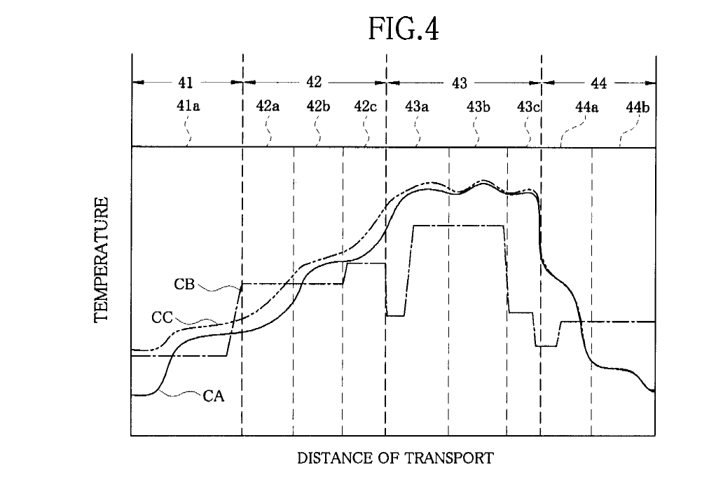

In FIG. 2, a portion of the tentering machine at an upstream end is viewed in a plan. In FIG. 3, the upstream end is viewed in an elevation. An arrow A designates a transport direction of the polymer film 21 in the drawings. Also, the tentering machine 12 includes a transport device 32. The polymer film 21 is thermally stretched in a stretching chamber 31. Tenter clips 39 are incorporated in the transport device 32, and clamp and transport web edges of the polymer film 21. An upstream end of the transport device 32 and a start position of clamping the polymer film 21 with the tenter clips 39 are defined on an upstream side of the stretching chamber 31, but are not limited to this embodiment. For example, the stretching chamber 31 and the transport device 32 may be disposed to define the start position of clamping within the stretching chamber 31. Also, those may be disposed to define the upstream end of the transport device 32 within the stretching chamber 31. The far infrared heater 22 and the heat roller 33 are positioned upstream from the transport device 32.

The transport device 32 includes a first rail 35, a second rail 36, a first endless chain 37, and a second endless chain 38. The rails 35 and 36 transport the polymer film 21. The endless chains 37 and 38 guide the rails 35 and 36. The tenter clips 39 are secured to the endless chains 37 and 38 at a regular interval.

The endless chain 37 is meshed with a driving sprocket wheel (not shown) and a driven sprocket wheel 40. The endless chain 38 is meshed with a driving sprocket wheel (not shown) and a driven sprocket wheel 50. The endless chains 37 and 38 are guided by respectively the rails 35 and 36. The driving sprocket wheels are disposed at a downstream end (not shown) of the tentering machine 12. A driving mechanism (not shown) rotates each driving sprocket wheel to cause the driven sprocket wheels 40 and 50 to turn the endless chains 37 and 38.

The tenter clips 39 in the transport device 32 come to clamp the polymer film 21 in a position upstream from the end of the stretching chamber 31, so that the transport device 32 transports the polymer film 21 into the stretching chamber 31.

The far infrared heater 22 and the heat roller 33 as the preheater preheat the polymer film 21 before entry to the stretching chamber 31 for heat stretch of the polymer film 21. The temperature of the polymer film 21 is previously raised.

The stretching chamber 31 applies heat to the polymer film 21. The additive with a high boiling point, such as triphenyl phosphate (TPP), in the polymer film 21 is evaporated by heating. The additive in the gas phase is present in the stretching chamber 31. In the condition of the high boiling point, a change from the gas phase to the liquid phase at a high temperature is easy. Thus, the additive as off-gas is likely to condense. Condensation of the additive with the high boiling point on the film surface may cause dirt on the polymer film 21 as a product, because the additive solidifies upon cooling. Let T deg. C. be the condensation temperature (dew point) of the additive as high boiling component contained in the off-gas at the upstream end of the stretching chamber 31. Should plural additives be contained in the off-gas, T deg. C. is defined as the highest of the condensation temperatures of the plural additives. It is conceivable that the condensation temperature of the additive as high boiling component is not detectable at an upstream end 51 of the stretching chamber 31. For such a situation, it is possible to use the off-gas within the stretching chamber 31 and near to the upstream end 51. The condensation temperature of the additive contained in the off-gas is temperature T deg. C.

An example of method of measuring the condensation temperature is the humidity-measurement method, JIS Z 8806-2001. The above-indicated values of the condensation temperature are obtained by a chilled mirror type of dew point analyzer as an automatic equilibration dew point analyzer determined in the JIS, specifically S4000 RS/TRS (trade name) manufactured by Michell Instruments Ltd. However, the method of measuring the condensation temperature is not limited in the present invention, and may be any of other suitable measuring methods.

According to the invention, the polymer film 21 is preheated before entry to the stretching chamber 31. To this end, the far infrared heater 22 and the heat roller 33 are used. The temperature of the polymer film 21 in the entry to the stretching chamber 31 is controlled in a range equal to or higher than T+10 (deg. C.) and equal to or lower than T+80 (deg. C.). This prevents easy condensation of the high boiling component on the surface of the polymer film 21. Should the temperature of the polymer film 21 be lower than T+10 (deg. C.), a high boiling component will condense on the film surface. Should the temperature of the polymer film 21 be higher than T+80 (deg. C.), even a high boiling component kept for use in the film will start evaporation. If the additive as high boiling component is plasticizer, it is likely upon its evaporation that the polymer film 21 will tear in the course of stretch in the polymer film 21, or that the flexibility of the polymer film 21 will be insufficient. Furthermore, the temperature T1 of the polymer film 21 is preferably conditioned in a range equal to or higher than T+15 (deg. C.) and equal to or lower than T+70 (deg. C.), and desirably conditioned in a range equal to or higher than T+20 (deg. C.) and equal to or lower than T+60 (deg. C.). When the polymer film 21 contains a plurality of additives, and TPP among those has a highest one of their condensation temperatures, then the temperature of the polymer film 21 in the entry to the stretching chamber 31 is controlled in a range equal to or higher than T+10 (deg. C.) and equal to or lower than T+80 (deg. C.).

Note that it is known the that melting point of the TPP is 48-50 deg. C.

The condensation temperature of the additive as high boiling component at the upstream end of the stretching chamber 31 can be changed by changing the condensation temperature of the atmosphere within the stretching chamber 31 according to known techniques, such as changes in a flow rate of fresh air supplied into the stretching chamber 31 to heat the polymer film 21 without high boiling component. The drop of the condensation temperature can lower the temperature of the polymer film 21 upon its entry to the stretching chamber 31. This is effective in preventing thermal degradation of the polymer film 21.

To develop optical performance of the polymer film 21, heat is applied in the stretching chamber 31 to the polymer film 21 to raise the temperature. In the stretching chamber 31, a middle one of its split areas with respect to the transport direction of the polymer film 21 is assigned with the highest temperature range. Should the temperature at the upstream end 51 or the downstream end be as high as that in the middle area of the stretching chamber 31, the temperature of the polymer film 21 abruptly rises or drops upon entry to or discharge from the stretching chamber 31, to lower the optical performance of the polymer film 21. Thus, the optical performance of the polymer film 21 can be raised by heating up to the predetermined temperature at least briefly. Note that the temperature of the polymer film 21 is determined according to a type of the polymer to form the polymer film 21, additives, and the like.

When the polymer film 21 contains cellulose acylate as main component and TPP as high boiling component, the inner temperature of the stretching chamber 31 should be preferably set equal to or higher than 140 deg. C. and equal to or lower than 240 deg. C. so as to raise the temperature of the polymer film 21 in this range at least in a temporary manner. Thus, retardation or other optical performance of the polymer film 21 can be improved. The additive as high boiling component is the more likely to evaporate according to nearness of the temperature to 240 deg. C. as a high temperature level. Accordingly, the feature of the invention is specifically effective when the polymer film 21 is heated in the range of 140-240 deg. C. Note that the polymer film 21 of cellulose acylate may be torn if stretched in a condition over 240 deg. C.

The feature of the invention can be used in an on-line stretching system for stretch in a solution casting line, as well as an off-line stretching system. A self-supporting cast film is stretched in the tentering machine 12 in the solution casting line before complete drying in consideration of productivity, the total size of the solution casting line, and optical performance. The tentering machine 12 operates for both stretch and drying. The additive as high boiling component is likely to evaporate together with evaporation of solvent. An amount of the additive as high boiling component in the gas phase in the stretching chamber 31 increases gradually to condense the additive on the film surface. The feature of the invention is effective in preventing the condensation.

The rails 35 and 36 extend to the upstream end of the stretching chamber 31. The driven sprocket wheels 40 and 50 are respectively associated with the rails 35 and 36. The far infrared heater 22 and the heat roller 33 are preferably disposed between the upstream end of the stretching chamber 31 and a position being 3 meters distant from the upstream end. This is because the polymer film 21 can be cooled before entry into the stretching chamber 31 if the polymer film 21 is heated in the position which is over 3 meters distant from the upstream end of the driven sprocket wheels 40 and 50.

In the present embodiment, the far infrared heater 22 and the heat roller 33 are used for applying heat to the polymer film 21 of a portion short of the stretching chamber 31 to raise the temperature. However, heat can be applied by other structures. For example, only one of the far infrared heater 22 and the heat roller 33 may be used. Other heaters may be used in place of the far infrared heater 22, for example, a near infrared heater, heater/blower, and the like. The far infrared heater 22 applies far infrared rays to the polymer film 21. A near infrared heater applies near infrared rays to the polymer film 21. A heater/blower blows heated air to the polymer film 21. The heat roller 33 has a peripheral surface which contacts the polymer film 21 for heating. A controller (not shown) controls any of those types of heater for the purpose of conditioning the polymer film 21 at a suitable temperature.

FIG. 4 is a graph illustrating distribution of the temperature in the stretching chamber 31. A distance from the upstream end of the stretching chamber 31 in the transport direction is taken on the horizontal axis, which extends from the upstream end toward a downstream end of the stretching chamber. Temperature is taken on the vertical axis. A positive direction of the temperature is an upward direction. Four zones are split in the stretching chamber 31 according to the temperature condition, including a first zone 41, a second zone 42, a third zone 43 and a cooling zone or fourth zone 44.

A curve CA expresses the temperature of the polymer film in the four zones 41-44 according to the prior art, namely in the entry of the polymer film into the stretching chamber 31 without preheating. A phantom line CB expresses the condensation temperature of the additive as high boiling component evaporated from the polymer film and contained in off-gas in the four zones 41-44. A phantom line CC expresses the temperature of the polymer film in the four zones 41-44 according to the present invention.

In the stretching chamber 31, the film is drawn in the transverse direction. The film before stretch is heated in the first zone 41 to optimize the temperature of the film for stretch. In the second zone 42, the film from the first zone 41 is heated further, and stretched at the high temperature. The stretch is started from a position in the second zone 42. The term of the stretch is used to stand for widening the polymer film 21 by drawing. In the third zone 43, the film is thermally processed in the similar manner to the second zone 42. The thermal processing is carried out during or after the stretch, and develops retardation or other optical performance of the polymer film 21 in an intended manner. The stretch may continue in the third zone 43. In the cooling zone 44, the film is cooled after heating at the high temperature before transport out of the stretching chamber 31. Note that there are a controller and a blower (not shown), which is controlled by the controller, and blows hot air to adjust the temperature of the four zones 41-44.

In the embodiment, the second, third and cooling zones 42-44 are respectively split into smaller areas. The first zone 41 is constituted by a single area 41a. The second zone 42 includes three areas 42a, 42b and 42c. The third zone 43 includes three areas 43a, 43b and 43c. The cooling zone 44 includes two areas 44a and 44b. The number of the smaller areas into which the four zones 41-44 are split is not limited. For example, the first zone 41 may include three areas. Heated air is supplied to the areas 41a-44b to keep those conditioned at the respective constant temperature to optimize the stretch operation.

Also, it is possible in the areas 41a-44b in the tentering machine to reduce an amount of the evaporated additive. To this end, the off-gas is drawn to an outer reservoir, where the gaseous additive in the off-gas can be removed before the off-gas is heated and introduced again in the stretching chamber 31.

The curve CA and the phantom lines CB and CC are shaped with temperature distribution according to the temperature set in the four zones 41-44. In each of the areas 41a-44b, the temperature is discretely determined. The temperature of the polymer film changes according to the set temperature of the areas 41a-44b. For example, the temperature of the film on the curve CA is remarkably lower than the condensation temperature of the additive with the high boiling point on the phantom line CB in the area 41a which is located near to an upstream end of the stretching chamber 31. It is very likely that additive with the high boiling point, evaporated from the film, condenses on the surface of the film.

In the area 41a, the temperature of the polymer film 21 according to the invention is higher than the condensation temperature of the additive with the high boiling point evaporated from the polymer film 21, as is indicated by the phantom lines CB and CC. This is because the far infrared heater 22 and the heat roller 33 as the preheater preheat the polymer film 21 before entry in the stretching chamber 31 to set the film temperature higher than the condensation temperature of the additive evaporated from the polymer film 21 in the area 41a. It is possible in the area 41a to prevent condensation of an evaporated component near to the upstream end of the stretching chamber 31 in relation to the surface of the polymer film 21.

Even in the areas 42a, 42b, 44a and 44b, the temperature of the film becomes lower than the condensation temperature of the additive with the high boiling point evaporated with heat, in any of the operation according to the invention and the operation according to the prior art. See the curve CA and the phantom lines CB and CC. Thus, the additive with the high boiling point may condense on the film even in the areas 42a, 42b, 44a and 44b. However, it has been found that the additive condenses on the film remarkably in the area 41a in particular. As the condensation of the additive with the high boiling point in the area 41a on the upstream side is prevented, defects of the film as a product can be prevented very effectively.

In the stretch of the off-line stretching system for the polymer film 21 previously obtained by solution casting, the polymer film 21 to be processed is initially dry without solvent remaining in the liquid phase. The temperature in the stretch of the polymer film 21 in the stretching chamber is set higher in the off-line stretching system than in an on-line stretching system, because the polymer film 21 must be softened in an ensured manner even in the initially dry form. The additive contained in the polymer film 21 is specifically likely to evaporate and condense within the stretching chamber of the tentering machine of the off-line stretching system as well as that in the on-line stretching system. Thus, the feature of the invention is effective in the stretch in the off-line stretching system typically.

It is possible to prevent condensation of evaporated substance from the polymer film in the stretching chamber 31 on the surface of the polymer film. Occurrence of defects on the polymer film can be prevented as products.

### EXAMPLES

Examples of the invention are hereinafter described. The invention is not limited to those examples.

The polymer film 21 was stretched in the off-line stretching system 10 of FIG. 1. The film dispenser 18 with the film roll 17 supplied the polymer film 21, which was 2,500 mm wide and was transported at 50 m/s to pass the tentering machine 12, the heating chamber 14 and the cooling chamber 15. Then the film winder 27 wound the polymer film 21. Time of the transport was 2 hours.

The following was the composition of the polymer film 21 as cellulose acylate film. A plurality of additives were used, among which TPP had the highest condensation temperature.

Cellulose acylate . . . 90 wt. %

TPP . . . 7 wt. %

Additives other than TPP . . . 3 wt. %

The inner temperature of the tentering machine 12 was conditioned as illustrated in FIG. 4. The area 41a of the first zone 41 was conditioned at 100 deg. C. The areas 42a and 42b in the second zone 42 were conditioned at 200 deg. C. The area 42c was conditioned at 210 deg. C. The areas 43a and 43b in the third zone 43 were conditioned at 220 deg. C. The area 43c was conditioned at 150 deg. C. The areas 44a and 44b in the cooling zone 44 were conditioned at 150 deg. C. The temperature of the areas 43a and 43b was set the highest among the areas 41a-44b.

The condensation temperature of TPP in the off-gas shortly before entry to the stretching chamber 31 was approximately 50 deg. C.

In stretching the polymer film 21, applied heat was adjusted by the far infrared heater 22 and the heat roller 33 as the preheater, to adjust temperature (deg. C.) of the film shortly before entry in the stretching chamber 31 of the tentering machine 12.

[Sample 1]

The polymer film 21 was heated by control and adjustment of the far infrared heater 22 and the heat roller 33. Then the polymer film 21 was transported through the tentering machine 12. The temperature of the polymer film 21 shortly before entry to the stretching chamber 31 was 60 deg. C. No fine grains of TPP as condensate were present on the polymer film 21 transported out of the tentering machine (0 per sq. meter).

[Sample 2]

The condition for Sample 1 was repeated with a difference in that the temperature of the polymer film 21 shortly before entry to the stretching chamber 31 was 70 deg. C. No fine grains of TPP as condensate were present on the polymer film 21 transported out of the tentering machine (0 per sq. meter).

[Sample 3]

The condition for Sample 1 was repeated with a difference in that the temperature of the polymer film 21 shortly before entry to the stretching chamber 31 was 130 deg. C. No fine grains of TPP as condensate were present on the polymer film 21 transported out of the tentering machine (0 per sq. meter).

For comparison, experiments of comparative examples was conducted. The condition of Samples 1-3 was repeated but with a difference in the use of the far infrared heater 22 and the heat roller 33 to apply heat to the polymer film 21 before entry to the stretching chamber 31.

### Comparative Example 1

The polymer film 21 was transported through the tentering machine 12 without operating the far infrared heater 22 and the heat roller 33. The temperature of the polymer film 21 shortly before entry to the stretching chamber 31 was 30 deg. C. The number of fine grains of TPP on the polymer film 21 transported out of the tentering machine was 13 per sq. meter.

### Comparative Example 2

The polymer film 21 was heated by control and adjustment of the far infrared heater 22 and the heat roller 33. Then the polymer film 21 was transported through the tentering machine 12. The temperature of the polymer film 21 shortly before entry to the stretching chamber 31 was 40 deg. C. The number of fine grains of TPP on the polymer film 21 transported out of the tentering machine was 11 per sq. meter.

### Comparative Example 3

The condition for Comparative example 2 was repeated with a difference in that the temperature of the polymer film 21 shortly before entry to the stretching chamber 31 was 50 deg. C. The number of fine grains of TPP on the polymer film 21 transported out of the tentering machine was 4 per sq. meter.

### Comparative Example 4

The condition for Comparative example 2 was repeated with a difference in that the temperature of the polymer film 21 shortly before entry to the stretching chamber 31 was 150 deg. C. The number of fine grains of TPP on the polymer film 21 transported out of the tentering machine was 4 per sq. meter.

[Evaluation]

The polymer film 21 of Comparative examples 1-4 according to conventional techniques prior to the present invention and Samples 1-3 according to the invention was produced and evaluated. The number of fine grains of TPP, which were located on the polymer film 21 transported out of the tentering machine and had a length of 0.1 mm or more on the film surface, was counted (per sq. meter) by human eyes to evaluate pollution of the film surface. Results of Samples 1-3 and Comparative examples 1-4 are indicated in Table 1.

TABLE 1

| | Temperature of the film upon | No. of fine |
|---|---|---|
| | entry in stretching chamber | grains of TPP |
| | (deg. C.) | (per sq. meter) |
| Sample 1 | 60 | 0 |
| Sample 2 | 70 | 0 |
| Sample 3 | 130 | 0 |
| Comparative | 30 | 13 |
| example 1 | | |
| Comparative | 40 | 11 |
| example 2 | | |
| Comparative | 50 | 4 |
| example 3 | | |
| Comparative | 150 | 4 |
| example 4 | | |

In Comparative examples 1-3, the polymer film 21 was not preheated to the temperature equal to or higher than 60 deg. C., which is 10 deg. C. higher than 50 deg. C. as a condensation temperature of TPP contained in the off-gas present near to the upstream end of the tentering machine. However, in Comparative example 4, the polymer film 21 was preheated to the temperature equal to or higher than 130 deg. C., which is 80 deg. C. higher than 50 deg. C. as a condensation temperature of TPP. In Samples 1-3, the polymer film 21 was preheated to the temperature equal to or higher than 60 deg. C. and equal to or lower than 130 deg. C., the temperature values being higher than 50 deg. C. Accordingly, condensation of TPP was suppressed on the film surface by heating the film upstream from the tentering machine to the temperature equal to or higher than T+10 (deg. C.) and equal to or lower than T+80 (deg. C.).

Furthermore, Samples 4-9 were prepared for experiment. The condition of Samples 1-3 was repeated but with a difference in the temperature of the zones 41-44. The inner temperature was set to increase from the area 41a toward the area 43a, and was set to decrease from the area 43a toward the area 44b. The condensation temperature of TPP in the off-gas shortly before entry to the stretching chamber 31 was approximately 50 deg. C. The temperature of the polymer film 21 shortly before entry to the stretching chamber 31 was 70 deg. C. The polymer film 21 was stretched by the off-line stretching system 10 of FIG. 1 in the manner of Samples 1-3.

[Sample 4]

The temperature of the area 43a of the third zone 43 was 120 deg. C. No fine grains of TPP as condensate were present on the polymer film 21 transported out of the tentering machine (0 per sq. meter).

[Sample 5]

The condition for Sample 4 was repeated with a difference in that the temperature of the area 43a was 140 deg. C. No fine grains of TPP as condensate were present on the polymer film 21 transported out of the tentering machine (0 per sq. meter).

[Sample 6]

The condition for Sample 4 was repeated with a difference in that the temperature of the area 43a was 200 deg. C. No fine grains of TPP as condensate were present on the polymer film 21 transported out of the tentering machine (0 per sq. meter).

[Sample 7]

The condition for Sample 4 was repeated with a difference in that the temperature of the area 43a was 220 deg. C. No fine grains of TPP as condensate were present on the polymer film 21 transported out of the tentering machine (0 per sq. meter).

[Sample 8]

The condition for Sample 4 was repeated with a difference in that the temperature of the area 43a was 240 deg. C. No fine grains of TPP as condensate were present on the polymer film 21 transported out of the tentering machine (0 per sq. meter).

[Sample 9]

The condition for Sample 4 was repeated with a difference in that the temperature of the area 43a was 250 deg. C. The polymer film 21 broke when stretched. No evaluation of pollution of the polymer film 21 was possible.

Also, Comparative examples 5-10 were produced. The temperature of the polymer film 21 upon entry in the stretching chamber of the tentering machine 12 was conditioned differently from the invention. The condensation temperature of TPP in the off-gas shortly before entry to the stretching chamber 31 was approximately 50 deg. C. The temperature of the polymer film 21 shortly before entry to the stretching chamber 31 was 40 deg. C. The stretch of the polymer film 21 with the off-line stretching system 10 of FIG. 1 was repeated.

### Comparative Example 5

The temperature of the area 43a was 120 deg. C. The number of fine grains of TPP on the polymer film 21 transported out of the tentering machine was 3 per sq. meter.

### Comparative Example 6

The condition for Comparative example 5 was repeated with a difference in that the temperature of the area 43a was 140 deg. C. The number of fine grains of TPP on the polymer film 21 transported out of the tentering machine was 5 per sq. meter.

### Comparative Example 7

The condition for Comparative example 5 was repeated with a difference in that the temperature of the area 43a was 200 deg. C. The number of fine grains of TPP on the polymer film 21 transported out of the tentering machine was 10 per sq. meter.

### Comparative Example 8

The condition for Comparative example 5 was repeated with a difference in that the temperature of the area 43a was 220 deg. C. The number of fine grains of TPP on the polymer film 21 transported out of the tentering machine was 12 per sq. meter.

### Comparative Example 9

The condition for Comparative example 5 was repeated with a difference in that the temperature of the area 43a was 240 deg. C. The number of fine grains of TPP on the polymer film 21 transported out of the tentering machine was 15 per sq. meter.

### Comparative Example 10

The condition for Comparative example 5 was repeated with a difference in that the temperature of the area 43a was 250 deg. C. The polymer film 21 broke when stretched. No evaluation of pollution of the polymer film 21 was possible.

Pollution of the polymer film 21 was evaluated in the manner similar to Samples 1-3 for Samples 4-9 of the invention and Comparative examples 5-10 not according to the invention. Results of the evaluation are indicated in Table 2. A sign of “—” designates breakage of the polymer film 21.

TABLE 2

| | Temperature of | | |
|---|---|---|---|
| | the film upon | | No. of fine |
| | entry in | Temperature of | grains of TPP |
| | stretching | area 43a (deg. | (per sq. |
| | chamber (deg. C.) | C.) | meter) |
| Sample 4 | 70 | 120 | 0 |
| Sample 5 | 70 | 140 | 0 |
| Sample 6 | 70 | 200 | 0 |
| Sample 7 | 70 | 220 | 0 |
| Sample 8 | 70 | 240 | 0 |
| Sample 9 | 70 | 250 | — |
| Comparative | 40 | 120 | 3 |
| example 5 | | | |
| Comparative | 40 | 140 | 5 |
| example 6 | | | |
| Comparative | 40 | 200 | 10 |
| example 7 | | | |
| Comparative | 40 | 220 | 12 |
| example 8 | | | |
| Comparative | 40 | 240 | 15 |
| example 9 | | | |
| Comparative | 40 | 250 | — |
| example 10 | | | |

In Comparative examples 6-9 in which the area 43a was conditioned at the temperature of 140-240 deg. C., the additive as high boiling component contained in the polymer film 21 was likely to evaporate rapidly. Fine grains of TPP at a higher amount were found to be present on the polymer film 21 than that according to Comparative example 5. In contrast, in Samples 4-9 according to the present invention, pollution of the polymer film 21 was suppressed by preventing creation of condensate of TPP even in conditioning the area 43a at the temperature equal to or higher than 140 deg. C. and equal to or lower than 240 deg. C.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A polymer film stretching method comprising steps of:
drawing polymer film containing additive in a transverse direction while said polymer film is guided continuously and heated, by use of a tentering machine contained in a stretching chamber; and
heating said polymer film before entry to said stretching chamber to set temperature of said polymer film upon entry to said stretching chamber in a range equal to or higher than T+10 (deg. C.) and equal to or lower than T+80 (deg. C.), where T (deg. C.) is a condensation temperature of said additive evaporated in an upstream end of said stretching chamber.

2. A polymer film stretching method as defined in claim 1, wherein in said heating step, far infrared rays or near infrared rays are applied to said polymer film.

3. A polymer film stretching method as defined in claim 1, wherein in said heating step, heated air is blown to said polymer film.

4. A polymer film stretching method as defined in claim 1, wherein in said heating step, a peripheral surface of a heat roller contacts said polymer film.

5. A polymer film stretching method as defined in claim 1, wherein said polymer film is supplied from a film roll to said tentering machine.

6. A polymer film stretching method as defined in claim 1, wherein said polymer film contains cellulose acylate, said additive is triphenyl phosphate, and an inner temperature of said stretching chamber is equal to or higher than 140 deg. C. and equal to or lower than 240 deg. C.

7. A polymer film stretching method as defined in claim 1, further comprising steps of:
drawing gaseous medium out of said stretching chamber;
removing said additive from said gaseous medium;
heating said gaseous medium after removal; and
introducing said gaseous medium after heating into said stretching chamber.

8. A polymer film stretching method as defined in claim 1, wherein said stretching chamber includes:
a first zone positioned on an upstream side, and conditioned at a first inner temperature;
a second zone, positioned downstream from said first zone, and conditioned at a second inner temperature higher than said first inner temperature; and
a cooling zone, positioned downstream from said second zone, and conditioned at a cooling inner temperature lower than said second inner temperature.

9. A polymer film stretching system comprising:
a tentering machine for drawing polymer film containing additive in a transverse direction while said polymer film is guided continuously and heated;
a stretching chamber for containing said tentering machine; and
a preheater for heating said polymer film before entry to said stretching chamber to set temperature of said polymer film upon entry to said stretching chamber in a range equal to or higher than T+10 (deg. C.) and equal to or lower than T+80 (deg. C.), where T (deg. C.) is a condensation temperature of said additive evaporated in an upstream end of said stretching chamber.

10. A polymer film stretching system as defined in claim 9, wherein said preheater includes a far infrared heater for applying far infrared rays to said polymer film.

11. A polymer film stretching system as defined in claim 9, wherein said preheater includes a heat roller for contacting said polymer film with a peripheral surface thereof.

12. A polymer film stretching system as defined in claim 9, further comprising a film dispenser for supplying said polymer film from a film roll to said tentering machine.

13. A polymer film stretching system as defined in claim 9, wherein said polymer film contains cellulose acylate, said additive is triphenyl phosphate, and said polymer film is heated in said stretching chamber at an inner temperature equal to or higher than 140 deg. C. and equal to or lower than 240 deg. C.

14. A polymer film stretching system as defined in claim 9, wherein said stretching chamber includes:
a first zone positioned on an upstream side, and conditioned at a first inner temperature;
a second zone, positioned downstream from said first zone, and conditioned at a second inner temperature higher than said first inner temperature; and
a cooling zone, positioned downstream from said second zone, and conditioned at a cooling inner temperature lower than said second inner temperature.
